(19) United States
(12) Patent Application Publication
(10) Pub. No.: US 2020/0258099 A1
(43) Pub. Date: Aug. 13, 2020

(54) Systems And Methods For Verifiable Peer To Peer Communication

(71) Applicant: Mansour Alghamdi, Irvine, CA (US)

(72) Inventor: Mansour Alghamdi, Irvine, CA (US)

(21) Appl. No.: 16/790,593

(22) Filed: Feb. 13, 2020

Related U.S. Application Data
(60) Provisional application No. 62/918,789, filed on Feb. 13, 2019.

(51) Int. Cl. G06Q 30/02; G06F 16/182; G06F 16/18

(52) U.S. Cl. CPC G06Q 30/0201; G06Q 30/0261; G06F 16/1805; G06F 16/1834

(57) ABSTRACT

System and methods for facilitating interaction between peers are described. A data collection server can be used to compile and store information about each peer and is preferably set up to only store that information approved for storage by that peer. A message server can store messages created by peers, where each message includes message information and message criteria. Using the message criteria and other information such as that gleaned from prior interactions with messages, feedback from prior messages and so forth, a processor can compare the message criteria and information with the stored peer information and generate a set of targets for that message. The processor or other server can then transmit the message to each target. Preferably, user interaction with the message is tracked via a digital ledger and tagged with a time, a location, and user information as a transaction.

This application claims priority to U.S. provisional patent application having Ser. No. 62/918,789 filed on Feb. 13, 2019. This and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the invention is peer to peer communication.

### BACKGROUND

The following description includes information that may be useful in understanding the present invention. It is not an admission that any of the information provided herein is prior art or relevant to the presently claimed invention, or that any publication specifically or implicitly referenced is prior art.

The digitization of business and personal communication has merged into a complex clockwork embedded with numerous layers. Businesses often struggle for market penetration in a systematically flawed network, which has become a breeding ground for economic waste and fraud. It also exposes individuals to excessive advertisement and distractions that is often irrelevant and sometimes inappropriate.

The greatest inventions and technologies that changed the world have always been those that enhance connectivity and offer accessibility. Gutenberg's printing press made books available to the masses and inspired literacy. Radio, Telegram, and telephone connected people from city to city. Films and television served to unify nations. The internet has transcended culture and creed by bridging the world. Today, computers, tablets, and smartphones are ever present. Digital applications shape the way people live and connect to the world around them.

The most successful enterprises today are those that serve human beings in the most fundamental ways. They provide useful tools to facilitate life. GOOGLE® has distributed several technologies at no cost to help people: search engines, maps, entertainment services, mail servers, digital storage, news, etc. It operates by attracting a large user base and generating revenue through advertising. The global aggregate of business spends billions on digital advertising to plague their audience with popups, ads, and many ineffective tactics. Digital content platforms deliver user generated content and become the primary channel for advertising. The convoluted ad exchange linking senders and recipients is inefficient. The inability to accurately track digital spending and quantify the effectiveness results in inefficiency. In addition, the multiple layers between a brand and a customer can causes more than 40% of advertisement spending to be lost through the supply chain and with transaction fees. Furthermore, the content creators who make digital content on advertising platforms are often inadequately compensated.

As a result, those companies that are frustrated are reaching out to digital ad agencies and influencers. Yet, as different influencers and platforms rise and falls, these companies lack a specific method for ad delivery. Many influencers are not being fairly or adequately rewarded for their content. Pricing of services is open ended and up to negotiation, rather than fixed upon effectiveness. Consequently, the victim in the story is the platform user. Users get bombarded with both relevant and irrelevant information that work to influence them. Users are losing trust that their information is being used against them. This system of digital advertising needs to deliver more value to all parties involved.

The current platforms generally are more centralized and act as third parties for marketing and delivering advertising to users. This creates a big gap between the two sides of marketplace. On the first side, the media users share their life and daily experiences and their interests for example through the social media. On the other side, vendors consider social media as a powerful tool to target their interested customers. Media users often lack any control over the information they share, and their data is typically sold many times to advertisers and others without the consent of the users.

Users also have little control over their private information, which gets sold and resold dozens of times. Often, users are interrupted with advertising that is irrelevant or poorly timed.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Thus, there is still a need for systems and methods for communication between peers, and in some embodiments, communication systems and methods that permit users to control their information and acceptance of advertisement.

### SUMMARY OF THE INVENTION

The inventive subject matter provides apparatus, systems and methods for automating advertising, e-commerce, and social peer-to-peer communication. In one embodiment, a system for facilitating an interaction between peers comprises a data collection server configured to compile and store user information about a plurality of peers. The user information may include, for example, daily activities, spending habits, hobbies, travels, entertainment, feedback, likes, dislikes, comments, reviews, daily needs, requests, searches, follows, media libraries, interests, surveys, moods, news, location pinpoints, daily schedule, favorite places, advertisement tracking, and promotion use.

Contemplated peers can include, for example, individuals, companies and other entities having one or more brands, online stores, institutions, organizations, retailers, advertisers, suppliers, demanders, service providers, service requesters, marketers, influencers, announcers, physical locations, physical things, digital locations, digital things, virtual locations, virtual things, message senders, message sources, message participants, digital platforms, mobile apps, social media network, and publishers.

The system may further comprise a message server configured to store one or more messages. Preferably, each message comprises message information and message criteria. The message information is essentially the content of the message and could be any combination of text, images, audio, videos, website address, virtual reality file, augmented reality elements, and so forth. Exemplary message content includes, for example, advertisements, discounts, coupons, personal messages, surveys, exams, quizzes, opinions, and so forth. The message criteria can be message dependent and set forth the conditions for receiving the message. Such conditions could include, for example, a specific value or a range of values for at least one of demographics, age, gender, language, a home location, a current location, interests, and hobbies of a desired target peer.

A processor can be configured to compare the message criteria with the stored user information and generate a set of targets. The processor may then transmit, or cause to be transmitted, the first message to each target of the set.

Preferably, the system is further configured to track interaction with the first message using a digital ledger, such that each interaction by a user is tagged with a time, a location, and user information and recorded on the digital ledger and acts as a transaction stored on the digital ledger. An exemplary digital ledger includes Blockchain, but any commercially suitable digital edger could be used. Preferably, such ledgers are decentralized and capable of clearly tracking all transactions and for more private and secured data.

Using the systems and methods contemplated herein, users can be rewarded for interacting with advertising or other content. Such interactions could include, for example, acting or responding to the message such as viewing the message, clicking a link in the message, answering a question, purchasing a product or service, providing feedback, or sending a reply message. In this manner, users can limit access to their information and limit third-party content to those times and places where the user may be interested in viewing the advertising other content. For example, the content could comprise an augmented reality vehicle that leads users to interactive experiences. Ultimately, user participation can earn generate revenue for both marketers, decentralized intermediate technology, and users.

In the systems and methods described herein, each peer, which may be an individual or a company or other legal entity. The systems described herein are not closed systems and could include and/or be compatible with current and future digital platforms, mobile apps, and publishers who can sign up to deliver messages to targeted peers who explore the publisher's contents.

Each peer can register as an account holder whose information is kept private and not bought or sold unless approved by the peer.

Messages can be created and sent through the platform embodied in the systems and methods described herein. Contemplated messages could be, for example, advertisements, greetings, solicitations, or any form of communication between account holders (peers). However, unlike prior art systems, messages cannot be delivered to a user (peer) unless the user has agreed to accept that communication or set a broader acceptance policy under which the communication falls. As incentive to accept and/or interact with the communication, the sender could offer a reward to the recipient using the system. In this manner, each user can opt not to receive messages, however, the user may be rewarded if they chose to view and interact with a message.

In some embodiments, contemplated systems and methods can comprise artificial intelligence algorithms that can be used to collect, learn, and understand backend data about message recipients and senders to determine relevance and more precisely target interested recipients. An optional feedback system from message recipients can assist in correcting and routing messages that correspond to the recipient's interests, activities, behavior, habits, desires, and/or needs, for example. In this way, the user's choice to spend attention is streamlined. The benefit to the message sender is obtaining valuable information concerning the success of a message and options of targeting. The message sender can be provided with real-time data that allows the sender to understand the effectiveness of a message and its targeting. This data can be further analyzed by the system to provide the message sender alternatives and hints to help a message campaign be more successful. In this manner, messages can be better targeted to interested users to thereby reduce wasteful messages to recipients who are not interested.

It is contemplated that the systems and methods described herein could be used on a variety of platforms including, for example, direct calling, texting, message text, message picture, message video, video call, augmented reality (AR) call, commercial messages such as coupons, promotional messages, discounts message, advertising message, pop up advertising, embedded advertising in websites and software applications, and so forth. The users of the system will be able to experience the communication messages in different ways like interacting with the message in AR or virtual reality (VR) form, playing interactive games, participating in the experiences and messages and sharing them on social media or other platforms.

To improve engagement with messages, recipients can utilize the systems and methods to post media in any location with pinpoints and virtual marks. Pinpoints allow GPS location of account holder messages and virtual marks allows other account holders to find those messages. In this way, account holders can have and share real-world events and experiences, which are supported virtually and digitally. The system may further allow account holders access to tools to generate and publish individual AR experiences or other virtual forms. Account holders would be able to share or sell their AR creations with other account holders.

The system allows for integration with Internet of Things (IOT) devices. This means that an account holder can user their smart phone or other device to send or deliver messages to other account holders.

It is contemplated that rewards and other transactions can utilize a point system to avoid exchange fees between account holders, especially where currencies may differ. By utilizing a decentralized, digital ledger, the point system can be transparent and prevent fraud. In some embodiments, each point could be based on the token of a digital cryptocurrency that can be exchanged by users or pegged at a specific cash value ratio. These points can therefore be converted to physical currency or could be used in exchange for products or services.

The systems and methods described herein advantageously permits each account holder to receive financial compensation and control their messaging, removing control from the small group that currently controls most advertising markets. Account holders can create and broadcast their own media channels for other account holders to experience and follow and get rewarded based on metrics that are transparent and applied equally to all users. Such metrics could include, for example, the volume of viewers, amount time spent, quantity of positive feedback, number of favorable reviews, and so forth. Contemplated systems and methods are configured to calculate the weight of each metric to determine the amount of points to be awarded for the particular channel for the broadcast. The channels can be exposed in various venues and may attract advertisers based on time and location of the broadcast. Additionally, links to each channel can be posted virtually at geographic locations. For example, if an account holder is a world traveler, they can pinpoint various locations where their channel broadcasts specific messages relevant to that location. This way, the other accounts that follow can physically travel along the same path to experience those messages. Furthermore, the channel owner can alert nearby account holders of updates and new content remotely. As some broadcasts are location based, this encourages people to venture out into the real world while they experience things digitally and virtually.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 illustrates one embodiment of a system for communication between peers.

FIG. 2 illustrates the system as used for data collection.

FIG. 3 illustrates the system as used for message creation.

FIG. 4 illustrates the system as used for message feedback.

FIG. 5 illustrates the system as used for facilitating a transaction.

FIG. 6 illustrates the system as used with a third-party platform.

FIG. 7 illustrates a flowchart for verification of a peer to peer communication.

FIG. 8 illustrates a flowchart showing the interaction between peers and the system.

### DETAILED DESCRIPTION

Throughout the following discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, blockchain as a service (baas) server, or other type of computer server in a manner to fulfill described roles, responsibilities, or functions.

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

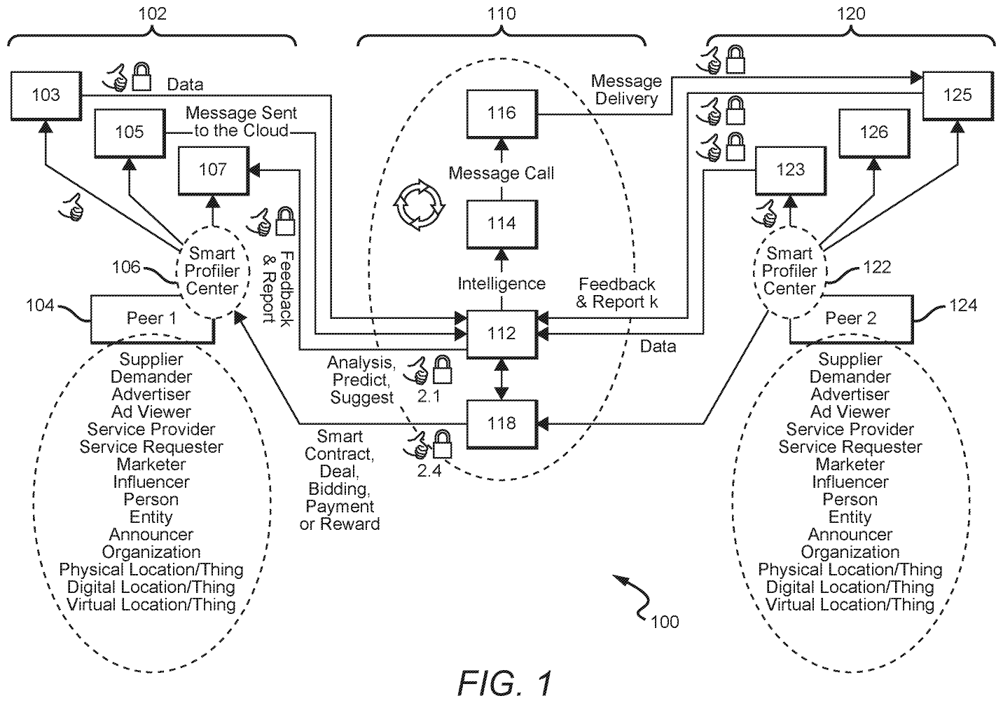

FIGS. 1-8 illustrate one embodiment of a system 100 for facilitating a communication or other interaction between peers. As shown in FIG. 1, the system 100 is divided into three areas 102, 110, 120. The first area 102 comprises a message source, which may include, for example, publishers, advertisers or vendors (buyers of another user's time). The publisher, for example, can be a peer who offers content via a digital platform using system 100. In addition, messages can be hosted and targeted to other peers who can be rewarded for their interaction with the messages.

The middle area 110 comprises the hardware and software forming the platform that facilitate transactions between the different users (peers) of the system 100. In this area 110 there is an intelligence server 112 which is the deep learning and artificial intelligence (AI) tool of the system 100. The intelligence server 112 is configured to collect participants' information and analyze it for later use. The third area 120 comprises a channel to the participants who are the recipients (sellers of time) in this model. This could include users who opt to sell their personal information or time in exchange for monetary or other compensation for viewing or otherwise interacting with messages.

Using system 100, a user (peer) 104 can promote products and services to a community comprising one or more peers 124. In this manner, anyone with or without a business is empowered to directly reach prospective customers, without requiring a third party thereby reducing cost and increasing efficiency of the communication.

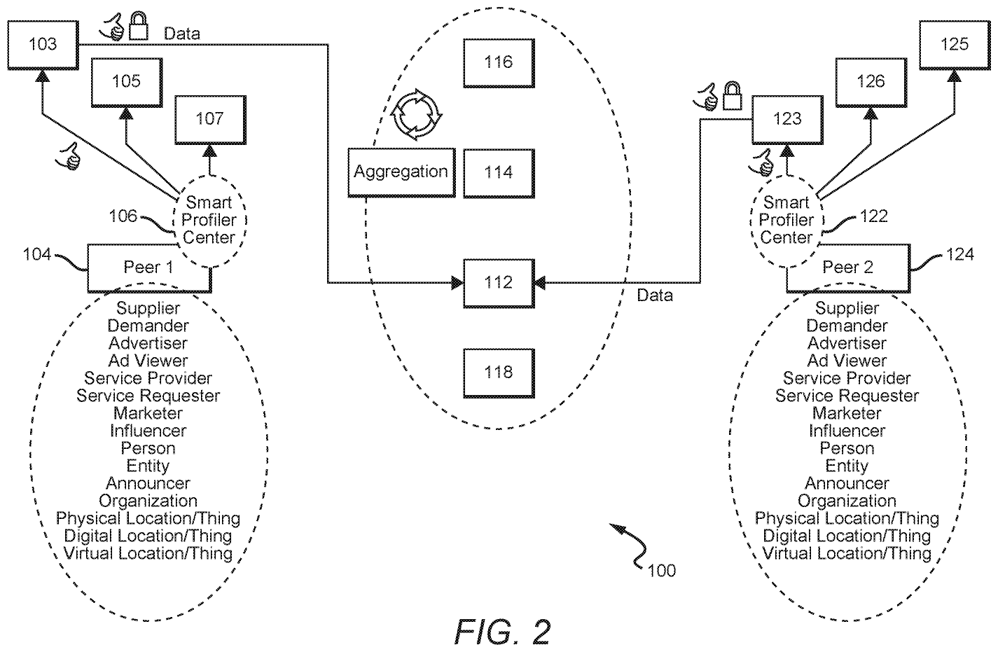

Using the data collection server 123, user 124 and other users can select the advertising and other messages with which the user 124 would like to participate, as well as the information the user 124 would like to share via profile server 122. For example, the data collection server 123 can be configured to compile and store user information about a plurality of peers. Contemplated user information can include, for example, daily activities, spending habits, hobbies, travels, entertainment, feedback, likes, dislikes, comments, reviews, daily needs, requests, searches, follows, media libraries, interests, surveys, moods, news, location pinpoints, daily schedule, favorite places, ad tracking, and promotion use. Other information can include, for example, a user's lifestyle, profession, demographics, name, age, nickname, contact information, culture, experiences, resume, skills, pictures, videos, location, business, bio, messages, social media accounts, status, website, activities, broadcasts, preferences, religion, and digital business card. FIG. 2 illustrates an exemplary workflow for data collection. However, it is preferred that the user information compiled and stored by the data collection server 123 is limited by a user's permissions.

In some embodiments, user 124 may store messages or manage the messages received via message manager server 126.

Optionally, user 104 can also provide information to the server 112 about the user 104 via data collection server 103. This may include profile information about a business, videos, images, and other content or information.

Thus, instead of companies fighting to access and influence their audience, system 100 gives the individual users control. In this manner, user 124 and other users can filter the most relevant products and services that meet their needs by experiencing the goods or services through different channels including AR and VR platforms, for example. System 100 provides users the ability to control via profile server 122 what information about themselves they would like to share in order to filter the content/messages they receive.

Peer 124 can register an account with the data collection server 123 and provide details for their personal and public information, such as that described above. In this manner, each peer can create a public or private profile to share messages, goods, services, events, activities, and media.

In some embodiments, profile server 122 can be installed or otherwise accessed on a user's device (such as a smart phone, tablet PC, or other computer). The profile server 122 can be used to collect information about the user, some or all of which can be transmitted to the data collection server 123. Such information could include handle, location, contact info, social media handles, profile picture, locations where messages can be delivered, items being sold by peer, services rendered by peer, items peer is seeking, and so forth.

In some embodiments, when creating an account, user 124 may be asked to verify the user's identity by adding banking account information, tax identification information or other identifying information. This helps to secure the message senders' investments and to prevent fraud from fake message views. It is contemplated that unique view counts can be limited to users with unique peer information as verified by banking account information, for example. The listed bank account of user 124 should match the name on the user's account information. The user's current geographical location data, as gathered from the user's IP address or user device, can also be used to ensure only one peer at any given time can access and utilize system 100 through an account to prevent fraudulent redundancy of account use.

In some embodiments, it is contemplated that the information about user 124 and other users can be collected by asking the user to take surveys provided by the data collection server 123. The survey answer can be stored on the server 123. The surveys may include questions concerning the user's interests, attitudes, opinions, hobbies, special needs, medical conditions, preferences, activities, culture, emotion, favorites, favorite products, favorite services, favorite brands, favorite media, favorite books, and the like. Example surveys could include, for example, interactive games, puzzles, and multiple-choice formats in addition to text-based answers. The user's collected answers can be categorized and measured by data collection server 123 to extrapolate one or more of age, gender, geographic location, occupation, participations, feedback, colors photographed, sounds recorded, locations visited, accounts followed, deals, offering pages viewed, surveys, mood, avatar, and so forth.

It is contemplated that interests/needs of user 124 or other users could be determined by first determining the user's mood. This can be accomplished, for example, by using facial recognition technology to examine a user's facial expression. Additionally, a behavior of the user can be tracked and analyzed to look for patterns that may indicate a mood. Of course, the system, could also permit a user to input a mood via emojis, text selection or other manner.

Based on the determined mood, the system 100 may suggest one or more message or products. For example, if a user if tired, system 100 may suggest sleep aids, pillows, and so forth. If someone is sore, system 100 may suggest a massage and recommend nearby businesses. Such suggestions could depend on a time and location of the user. In this manner, system 100 can elicit offers from nearby service providers that complement the user's mood.

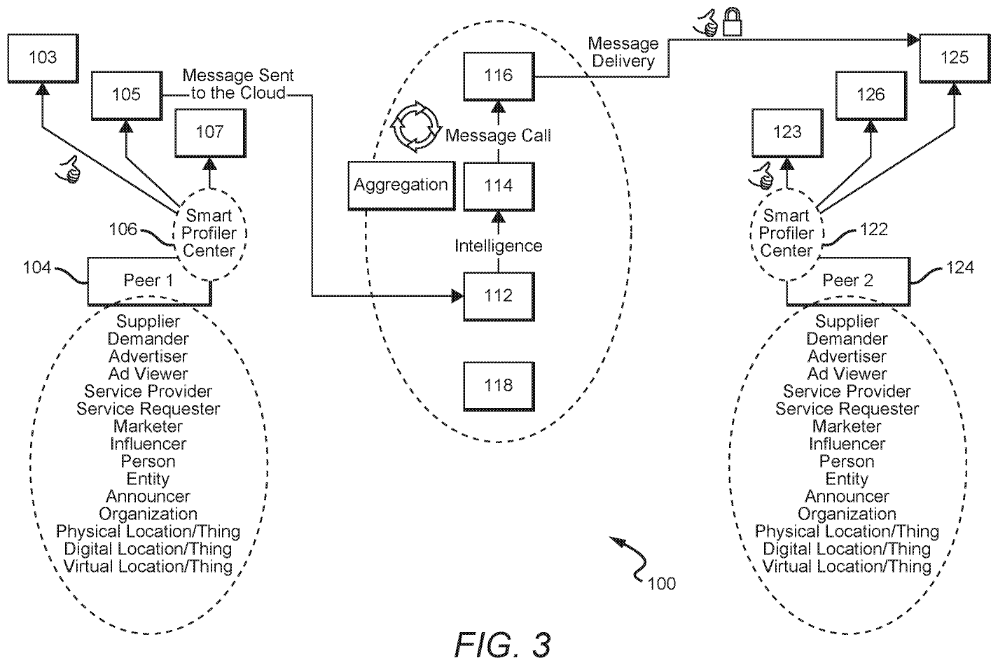

System 100 can further include a central message server 114 configured to store a plurality of messages from various users including a first message. Preferably, each of the messages comprises message information and message criteria. Contemplated message information can include, for example, on or more of an audio file, a video file, a text file, an image file, a website (IP) address, a virtual reality file, and an augmented reality file. FIG. 3 illustrates an exemplary workflow for a message creation.

The message criteria may include for example a selection of specific values or a range of values for one or more of demographics, age, gender, language, a home location, a current location, interests, hobbies, and so forth of a desired target peer.

Using message server 105, it is contemplated that user 104 can create, review or edit one or more messages. In some embodiments, the message could be an augmented reality experience. In other embodiments, the message could comprise games, advertising, coupons, discounts, or promotions, for example.

Messages can also include a preferred channel of communication, which could include, for example, a physical location, a digital channel, a map channel, and a virtual channel. The direct channel can comprise a direct communication between a user and an owner of the message, which may occur via a virtual channel that comprises one of a game, a forum, an augmented reality overlay, a webpage, and so forth.

Message server 105 preferably comprises a user interface that permits user 104 to design, create, add message criteria, upload, and monitor the message. The message could be in the forms of audio, video, text, image, 2D, 3D, VR, AR and so forth.

User 104 can utilize a profile server 106, which may reside on a distal computer or on the user's computing device. Profile server 106 is communicatively coupled with the message server 105, and can facilitate the user's account creation, for example.

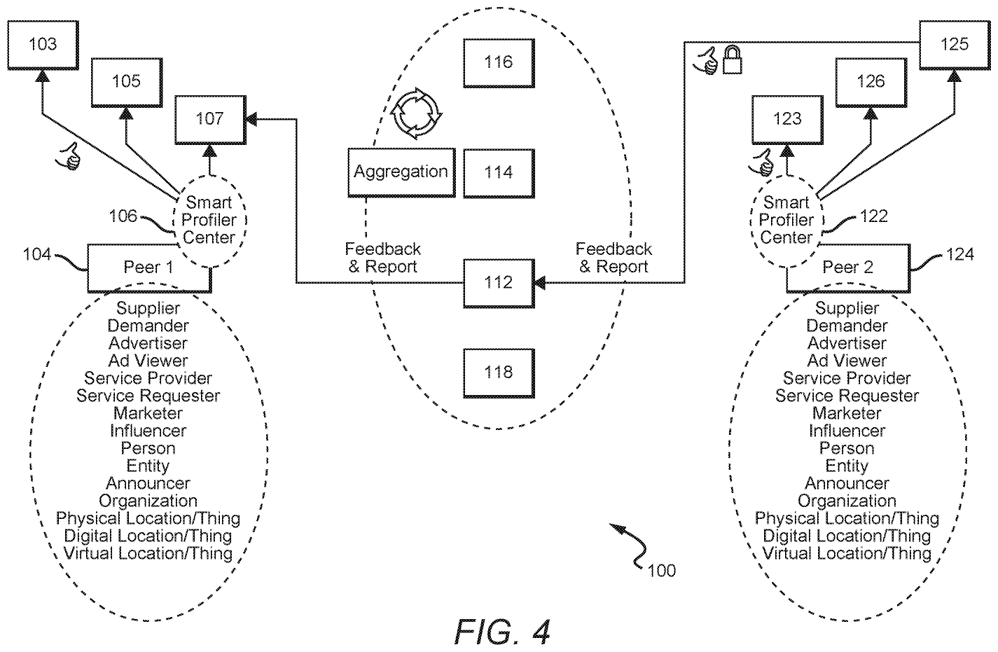

Messages from the message server 105 can be transmitted and stored at a central message server 114 via the message transmission server 112. Server 114 acts as a central storage location for messages and assists with message delivery via the coordinating server 116. The central message server 114 or message transmission server 112 can be configured to provide reporting of message delivery, message viewing, message impressions, message interaction, and message feedback. Feedback can then be transmitted to connection server 107 for review by user 104. An example of this is shown in FIG. 4.

Message transmission server 112 collects the messages from the different peers (the message sources) and manages the stored messages for transmission to users via coordinating server 116. The transmission server 112 preferably comprises a processor that utilizes one or more algorithms to analyze each message to understand the message criteria and sort or group the messages. Message transmission server 112 can be configured to identify additional message delivery factors (message criteria) than those selected by user 104.

Preferably, the processor is configured to compare the message criteria of a message with the stored user information and generate a set of targets or recipients for the message. The set of targets can be generated by comparing the message criteria with the stored user information and creating a subset of users that match the criteria. Thus, for example, if a criterion is people within a certain age range, the subset can include all users who shared their age information and fall within the specified age range. Contemplated targets of the set can include, for example, a plurality of users, one or more physical locations, or combinations thereof.

Apart from direct comparison of values to select targets of a message, it is contemplated that system 100 can improve targeting, and potentially include users falling outside of the message criteria, by utilizing machine learning algorithms. The system 100 can also be configured to analyze message recipients to identify, categorize, and sort potential audiences.

In some embodiments, the processor can be configured to convert message information and information about the users into a coded or crypto data for an additional layer of security using artificial intelligence and/or Blockchain technologies. The message information can be assessed using software tools including, for example, image recognition, language recognition, audio/video analysis, location analysis, and context interpretation to recognize patterns and generate data. Using this information, the processor can predict and suggest data matching and message recipients and can store and retrieve the data and the uploaded messages efficiently and securely using the central message server 114.

The processor is further configured to transmit, or cause to be transmitted, the message to each target of the set of targets. When desired, peer 124 or other users can view and interact with the message via connection server 125. Connection server 125 also is configured to facilitate communicate with the message sender or/and feedback regarding messages and the contents of the messages, which can be sent to message transmission server 112. Connection server 125 is further configured to facilitate transactions, such as through a direct channel between users facilitated by the transaction server 118. Message interaction input and output features can be done, for example, by a mobile device such as accelerometer, camera, microphone, speaker, display, gyroscope, GPS, magnetometer, and the like. Also, connection server 125 can open a channel from the recipient to the message sender for continued communication.

In some embodiments, connection server 125 can further be configured to provide access to discover, explore, find, and search for people, places, news, goods, services, events, promotions, and the like.

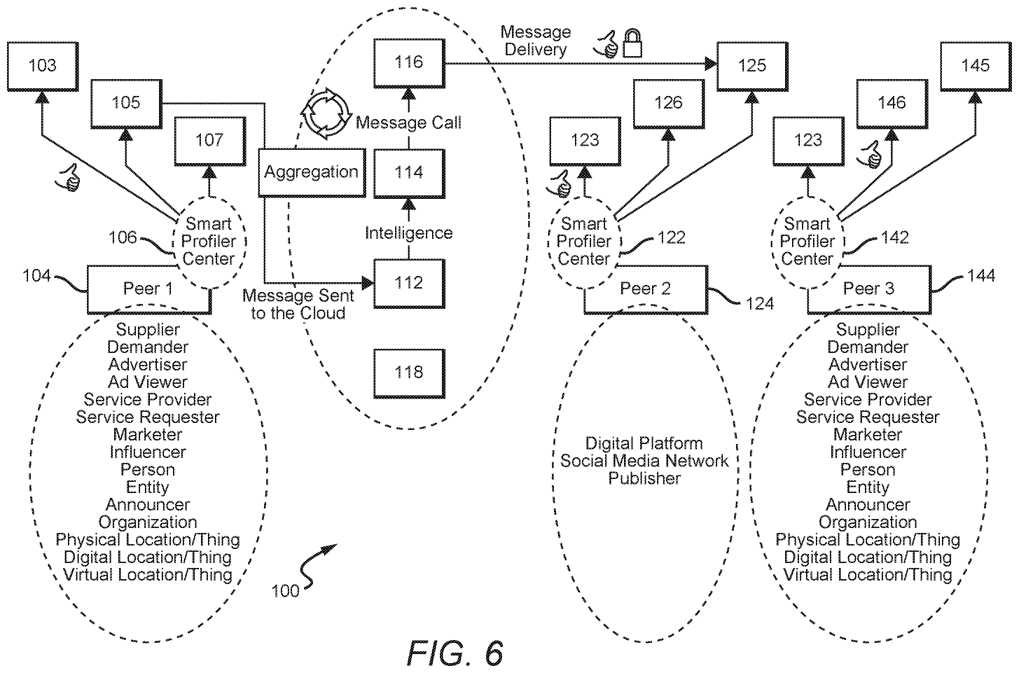

As shown in FIG. 6, the processor can be configured to transmit, or cause to be transmitted, the message to a plurality of targets (here, peer 124 and peer 124). Connection server 125 receives a message from coordinating server 116, and transmits the message to profile server 142 of peer 144. Like that described above, profile server 142 can be disposed on or otherwise accessed from a computing device of peer 144.

Profile server 142 can be configured to interact with each of data collection server 143, message manager server 146, and connection server 145. These devices interact with profile server and provide similar functionality to data collection server 123, message manager server 126, and connection server 125, respectively. As shown in this figure, the system 100 can transmit a message to multiple peers who can then each interact with the message and/or provide feedback, which is then transmitted to intelligence server 112 for review and analysis. With respect to the remaining numerals in FIG. 6, the same considerations for like components with like numerals of FIG. 1 apply.

The processor can be further configured to track interaction with each message using a digital ledger, such that each interaction by a user is tagged with a time, a location, and user information and recorded on the digital ledger. In this manner, each interaction can comprise a transaction on the digital ledger. It is preferred that the digital ledger comprises a decentralized blockchain, but any commercially suitable digital ledger could be used.

In such embodiments, the processor of the message transmission server 112 can be configured to review the transactions on the digital ledger and determine what patterns exist among the transactions by examining transmission of messages and interactions of the transmitted messages. Preferably, the digital ledger comprises a searchable index that contains one or more of the following: the user information, the location, the time, a viewing time, an internet address, a feedback, and a response.

Using the digital ledger mechanism such as blockchain, each user interaction with the system 100 is recorded for several purposes. The smart profile tags each action with time, location, user information, and other such variables that can be used to understand patterns for each user. The user patterns are recorded in the digital ledger which can also be accessed by the server ecosystem to improve relevancy and targeting. The user also retains ownership of the ledger and has control for who can access their recorded information. The recorded information in the digital ledger is aggregated and verified when the user makes transactions to trace and secure such interactions. Each of the ledger records are hashed—meaning encrypted or/and encoded.

Contemplated interactions with a message include, for example, viewing the message, answering a question, taking a survey, watching a video, clicking a hyperlink, purchasing an item or service, sharing the message with another user, or redeeming a coupon.

To help incentivize users to interact with messages, it is contemplated that the users could be rewarded for some or all their interactions. Such rewards could include, for example, points, money, discounts, ticket for a drawing, free items or services, and so forth. Thus, a message can further include a value to be rewarded for interaction with the message. This can be facilitated by message server 125.

In some embodiments, it is contemplated that each user interaction can be recorded, preferably in the digital ledger. The system 100 can be configured to search for patterns of use to detect abuse and fraud. The transparency of each interaction allows for a searchable index of users, locations, time spent viewing, time of viewing, IP address, interactions, feedback, responses, and other data that may be scanned to detect bots, fake ads, fake views, farms, and any other subterfuge.

To facilitate an understanding of one aspect of the inventive subject matter described herein, an example is presented below of certain interactions with the system 100. This example should be construed as non-limiting.

As discussed above, peer 124 provides personal and public information to system 100 via profile server 122. Peer 124 has allowed system 100 to use this information in connection with advertising and other messaging. Profile server 122 identifies his location and time and sends a query to message transmission server 112. Message transmission server 112 hashes and encodes the data, then adds a tag to track the response of system 100 to peer the information and data of peer 124. The message transmission server 112 retrieves relevant messages from the central message server 114 based on the peer's 124 profile information. Data is sent back to peer 124 asking if there is interest in messages relevant to his interest in table games.

Peer 124 also messaged his friend about his interest in table games. Peer 124 has allowed system 100 via profile server 122 to use message information to find table games. The profile server 122 identified his current location and time and sends a query to message transmission server 112. The message transmission server 112 hashes and encodes the data, then adds a tag to track the response of system 100 to the desire of peer 124. The coordination server 116 retrieves relevant messages from the central message server 114. Data will be sent back to peer 124 asking if he has interest in messages relevant to his desire for table games.

Coordinating server 116 is configured to verify peer 124 (as the messages recipient) location, ID, information, data, needs, distention, time, requirements, activities, GPS, GIS and/or similar information for message delivery. Coordinating server 116 is also configured to coordinate the message delivery and links peer 124 with the selected message using the best channel(s) of delivery whether a physical, virtual, or digital channel.

Coordinating server 116 may further verify the real time location of peer 124 by comparing a reported location with a history of places visited by peer 124 to add additional anti-fraud security for message viewing using technologies like GPS, GIS and the like. Also, coordinating server 116 may check an IP address of the device of peer 124. This coordinating server 116 can also be configured to check the activities, previous and recent impressions, requirements, needs, curiosities, shopping behaviors and any other information of peer 124 that can help to link peer 124 with a proper message.

The next job of coordinating server 116 is to link message sender (peer 104) with a peer through a selected channel of viewing based on the matching criteria. The message delivery channels could be digital, virtual, or physical. Then the coordinating server 116 provides a report of all activities on the message. The coordinating server 116 is configured to request messages to match with recipients based on the message criteria.

Peer 104 (a message source) who is the owner of a games store decided to create interactive messages in the following forms: 3D mode, 360 video, AR view, VR view, exploratory view, shopping selections view, and some other options. In the profile server 106 and message server 105, peer 104 selects specific demographic, criteria and conditions to target the message and then uploads the message to message transmission server 112. Peer 104 also offers rewards in form of points (equals some amount of money) to buy an interested peer's time and attention to view and participate with the message.

Peer 104 created three different messages about three table games. The first message is an interactive advertisement about a table game for people between ages 18-25 years and any gender who are located at South Coast Plaza in Irvine, Calif. between 10 am to 5 pm. The second message is a table game for people between ages 25-30 years old. The third message is a 30% off coupon message targeting people who like video games between ages 18-25 years.

Peer 104 used geofencing and map tools to upload two of his messages and later visited South Coast Plaza and created a geomessage for his third message. Also, peer 104 allowed the use of his store's virtual guide or other different avatars (with extra rewards) for more explanations of the products and to increase engagement. Peer 104 uploaded the third message to the message transmission server 112. Peer 104 also paid the service fee and the rewards amounts.

Message transmission server 112 processes each message of peer 104 in two parts. The first part is hashing the message, meaning the message is encrypted and/or encoded. The second part is that the message transmission server 112 reviews the ledger associated with the message and message tags based on the message specifications. This is preferably accomplished using software algorithms utilizing machine learning that uses the data from the profile server 106 and associated data from peer 104 to categorize the message by adding tags to it. The system 100 learns, understands, and analyzes the message content. The message transmission server 112, based on data from profile server 106 and the message criteria and conditions, predicts and suggest message delivery targets by adding tags. In this manner, the central message server 114 can easily store and retrieve the message efficiently and securely.

The central message server 114 receives each message of peer 104 from the message transmission server 112 and stores the messages for later delivery.

Using data from the message transmission server 112, the coordination server 116 delivers a message from peer 104 to peer 124 because of the match of message criteria and conditions. The message is delivered at a specific time and location and via a specific channel based on the message criteria and suggested criteria from the message analysis above.

In general, the coordination server 116 is configured to improve message matching which includes optimizing message viewer targeting and delivery time, channel, and location based on the message source's (here, peer 104) set of the message criteria and conditions. The coordination server 116 will deliver the message of peer 104 reliably at the right time in the right location.

Peer 124 is in the parking lot of South Coast Plaza at 11 am and receives a notification of nearby messages. Peer 124 chooses to ignore the notification. Peer 124 decides to scan the environment around South Coast Plaza to discover the approximate offers and ads. Peer 124 is exposed to some messages from the surrounding markets and other peers matching his profile and interests. Peer 124 chooses one of the messages and accepts to view and participate with the message.

The message is from peer 104 and includes a link to the profile of peer 104. The message preview is from the store offering a discount for the list of items. Peer 124 reviews the items on the list and chooses a message for a table game. The message provides some interactive icons for peer 124 to try playing the table game in the real physical world. Peer 124 clicks on a specified icon on his device screen to start playing. The message is designed to provide peer 124 with some options to view and participate with the message including, for example, 3D mode, 360 video, AR view, VR view, exploratory view, shopping selections view, and some other options, to interact with the table game.

Peer 124 chooses the icon of AR view and receives the option to start interacting with the message. Peer 124 views an AR view for the game and starts playing the game in the real-world but with augmented reality elements overlaid. Peer 124 also finds a virtual guide set by peer 104 to explain some features of the table game and the business of peer 104. Peer 124 starts asking the virtual guide about the game and the virtual guide answers the questions. Peer 124 decides to choose a different avatar for the virtual guide, and searches for available avatars in system 100. Peer 124 finds his friend's avatar and requests the virtual guide to be his friend's avatar.

At the end of the interaction with the message, peer 124 provides feedback to peer 104 about the message and its content. Peer 124 decides to tell his friends about his experience, in the form of a recording of his experience with the message. Peer 124 shares the experience with a list of his friends and choose to share the original message of peer 104 with another peer. The other peer receives the message of peer 104 but rejects it. Meanwhile, peer 124 contacts the store of peer 104 via a direct communication using system 100 to ask about some other offers listed.

Finally, peer 124 decides to buy two table games. Peer 124 selects a purchase icon in the message. Each table game costs $35 for a total of $70, which in this example is equal to 700 points. Peer 124 redeems 500 points that he has previously earned (300 points as reward from previous participations and 200 points he bought from the system 100). Peer 124 pays for the remaining 200 points with $20 from the account linked in his profile. System 100 also offers peer 124 a cashback reward for the deal.

Peer 124 chooses to have one of the table games delivered to his location later in the day and allows the delivery person to find the specific location by scanning the environment during the delivery window. When the delivery driver arrives at the address specified for delivery, the driver uses the Augmented Reality view to recognize the virtual tag of peer 124 and navigates to his location.

Peer 124 decides to send the other table game to his friend as a gift. He opens his friends list and selects his friend as the recipient who then receives a real time notification of the current location of the virtual gift from peer 124. The friend accepts the gift which appears as a virtual creation in a form of AR game. The friend lists a preferred address to receive the gift from the store of peer 104, and the game is later delivered to that address. The friend later adds a five-star review for the table game with comments, and shares recorded experiences within the reviews for the product and store of peer 104.

After the interaction with the message by peer 124, the message transmission server 112 reports to peer 104 about the activities related to the message, which can be viewed in the connection server 107 associated with peer 104.

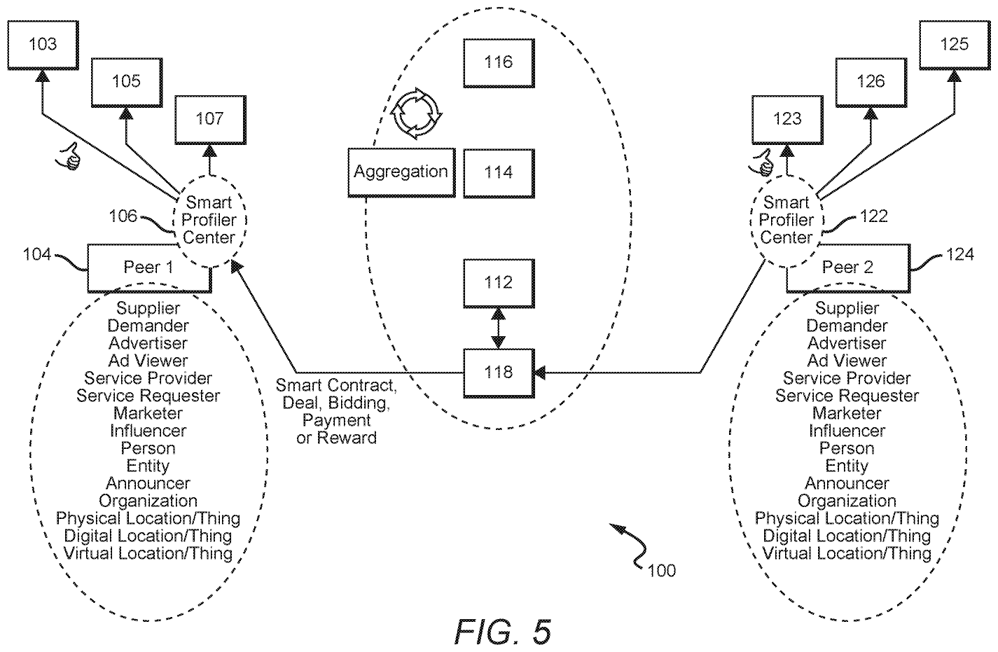

During the transaction to buy the two games, transaction server 118 processes the transaction and creates a contract between peer 104 and peer 124. The transaction server 118 processes the deal and complete the payment transaction. The transaction server 118 reports to peer 104 and peer 124 with the transaction. An example of this is shown in FIG. 5.

The transaction server 118 represents a trading desk where the peers can make payments, issue contracts, and deal with expected rewards. This is an additional layer of security and data integrity since it is an over end to end transaction process. This layer provides a trusted message distribution ledger which reflects ensured transparent transactions. The transaction server 118 is the field of where both the message sender and the message recipient enter a commercial process with/without a signed contract. This can confirm the availability of a credit line. From the peers' information, the transaction server 118 can connect peers for commercial deals and transaction in a transparency and auditability way because technology like AI and Blockchain helps to distribute the status and the ability for making a transaction for every participant peer. Additionally, the transaction server 118 helps to reduce the transactions risks. Fraud and freight transformation in transit can be minimized when utilizing transparent consensus data about ownership and responsibility over messages. More benefits form the transaction server 118 is to reduce the time and the cost of generating significant operational cost of end to end messaging, communicating, and transactions process.

Peer 104 had offered to reward viewing of the message. Because peer 124 accepted to interact with the message, the transaction server 118 rewards peer 124 for the participation and may reward his friend for the use of his avatar. The transaction server 118 reports to peer 104 and peer 124 about the activity, each of whom can access the transactions via the profile server.

As used herein, a digital message can be data encoded for transmission to another person or entity or encoded data received from another person or entity. In the crypto environment, messages can be signed, encrypted, or both. This kind of message can be placed for viewing for example through the system 100.

The geomessage is a digital message at a specific location, which permits the message source to create a message at a physical location and allow a message viewer to participate with the message or/and share it with others. This can be created remotely or while at the specific location. The message source specifies a specific location using technologies like GPS, geofencing area, a location on a map, a pinpoint of a current place of the message source, or a like. A message recipient may get notified of the message in the approximate area or location of the massage based on the matching criteria set by the sender. Also, the peer can find the message based on his/her search for the message such as by virtually scanning for the approximate environment, a digital search, or using the location map and the like. The message source has the option to put the message in a solid position or mobile message that allow the peer to track the message. the selection of a location digitally through the used a map system that allow the message source to select a location for the geomessage which will be driven by a coordinate system that positions the geomessage at a specific longitude, latitude, and height above or below sea level. The radius assigns the physical geographical endpoints to create geofencing for the avatar's visibility and application.

The virtual message is a digital message assigned by a message source for others in a virtual way. For example, it can be a message in a 3D view, AR view, VR view or the like and be able to be matched with a specific physical or digital thing. The physical things could be a building, nature, product, print, or a like. The digital things include any digital creation like photo, audio, video, or a like. The matching can be done with a specific search method.

Users could also create a message virtual trip which documents a virtual trip to help peers share and experience journeys using an electronic device to create content or virtual post at the different points in a trip. The trip is thus a connection of pinpoints from the start of a trip to the end of a trip that any pinpoints in-between. The message source will have the option to add content to each pinpoint which means to create a digital creation, message, or alike at any point of the trip tracking line. This option also is to create a challenge at each pinpoint includes creating AR Games, comment, reply, post, quiz, questions, survey, or the like.

The mobile message is a digital message set by a message source and enabled to be navigated in a pathway whether to guide, or to interact with a message viewer. The mobile message can be designed to be tracked virtually as an AR overlay of a navigable pathway to guide other peers from one point to another point. The AR overlay will display on the phone screen to direct and guide the other peers with audible prompts from, for example, an avatar. The virtual tracking could be a line of a mobile message with a visual indicator of the path taken through a trip where the other peers can see this tracking line. The peer has the option to assign a pinpoint as a destination.

In some embodiments, it is contemplated that a peer (message creator) can bid for message viewing through a specific channel. The limits on the number of messages of a channel may depend on the geography of the channel, for example. The bid could depend on the number of participants, the duration of the message, the duration of the displaying, the time of displaying the message, the target viewers for the message, the type of the message, and the length of the message, for example. The message source can bid several points/rewards to be allocated to the message. Only the top allocations that offer the best experiences for the channel participants will be selected based on metrics such as points, points per time/attention, interactivity, engagement, feedback from previous messages, company feedback, and/or previous message reviews.

As discussed above, users (peers) who interact with messages can provide feedback about the message, which can assist in sending more relevant messages to recipients. Feedback provided at different parts of the message cascade will hold different weight with respect to recipient participation and engagement. The lowest weight for feedback can be when participants don't even view the message. The highest weight for feedback can be after the recipient experiences and interacts with the message to completion. The system 100 compiles and quantifies the feedback to determine a message sender's trust, reliability, and quality of content. The value of the message allows the message sender to match with more recipients. Messages with greater value can be permitted to target more recipients in tangential categories of interest for broader distribution.

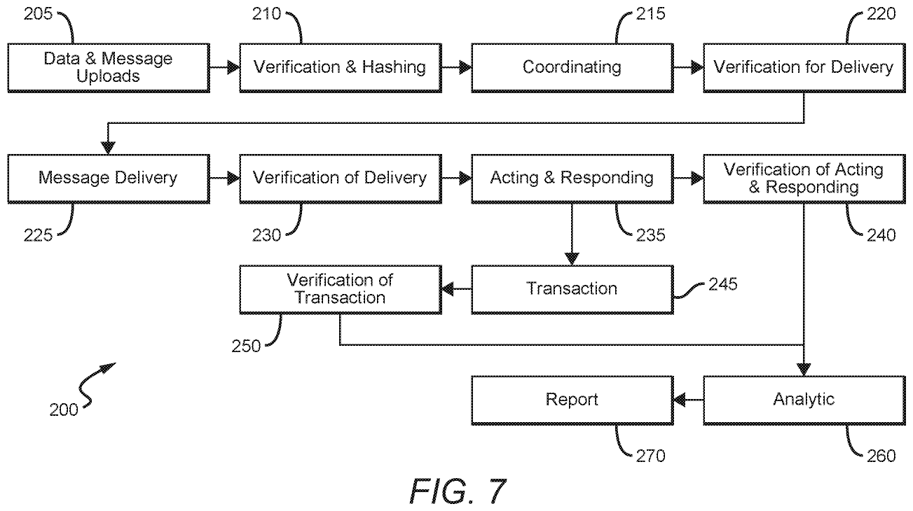

Methods for facilitating an interaction between peers are also contemplated. An exemplary method 200 shown in FIG. 7 include storing user information about a plurality of peers in a data collection server. Data and messages can be uploaded in step 205. Such user information can include, for example, at least one of daily activities, spending habits, hobbies, travels, entertainment, feedback, likes, dislikes, comments, reviews, daily needs, requests, searches, follows, media libraries, interests, surveys, moods, news, location pinpoints, daily schedule, favorite places, ad tracking, and promotion use.

Users and messages can be verified, and messages hashed in step 210 such as described above in relation to system 100.

Messages can be saved to a message server, where each message comprises content and message criteria. The message criteria can be compared with the stored user information to generate a first set of targets in step 215. The message can be verified for delivery in step 220.

Messages can then be transmitted to each of the targets of the first set in step 225, and their delivery verified in step 230. In some embodiments, a bid can be received from an owner of the message, and the message transmitted only if the bid meets a predefined criterion.

The methods can further include tracking interaction with the message by each target using a digital ledger in step 235, such that each interaction by a target is tagged with a time, a location, and user information and recorded on the digital ledger. Each interaction preferably comprises a transaction on the digital ledger for verification in step 240. The digital ledger may comprise a blockchain.

In some embodiments, the message criterion comprises a physical location. Preferably, the message is transmitted to targets located within a predetermined range from the physical location.

The recipient can initiate a transaction with the message sender in step 245 which can be verified in the manners described above. The interaction and any transactions can be reported to a central server and analyzed in step 260. Once analyzed, reports can be generated in step 270.

As described above, each peer can be a publisher, advertiser, message recipient, curator, or mobile node in a network of peers sharing messages. The system is configured to identify, verify, and record each peer's activity to learn and understand each peer's preferences, attitudes, behaviors, and desires. Each peer chooses what data is shared with the system. In addition, the system is secured to transparently and directly collect data with permission respective to each peer. The supply of data is preferably coded and not shared directly with any third party, so that each peer can maintain control over their data.

The systems and methods herein preferably related to an open system where current or future digital platform or publisher can participate as a peer. To participate, it is contemplated that all the digital platforms and publishers must agree to respect the users' data to receive messages (such as ads) for targeting a message viewer. They are thus publishers and not data collectors on the system, and data collection by third parties is restricted and prohibited. In this manner, the system can enhance the privacy, security, creativity, transparency of its users, which can lead to an efficient adverting, messaging, communicating, transaction space.

All information stored in the system is preferably coded to secure the data. The system's algorithms can use components of a peer's data for the purpose of learning and understanding how to accurately transact relevant messages connecting peers. Also, each peer's actions including, for example, providing data, paying attention, transacting, or responding to messages may be eligible for rewards. For example, a peer can earn rewards by allowing other peers to piggyback on the original message (advertise) or content of the message. The system can provide anonymous transaction data to message creators including, but not limited to verified views, hashes, access, and the like for the purpose of managing message campaigns.

Preferred systems include various anti-fraud features. One such feature involves data ownership. The suppliers of data to the system are peers who own and give permission to share their data and information for targeting and other transactions. No third parties will be allowed to access the peers' data for message targeting, or to be sold in the market for any other purpose.

As described above, to create a secure environment for peer-to-peer communicating, targeting, and interactions, each peer's identity can be verified with banking information, tax id, and other official documents. Verified peers can be eligible for broadcasting messages, conducting transactions, sending/receiving rewards, and the like. By verifying each peer, this creates accountability to prevent spurious content created by pseudonyms—fraudsters, bots and the like.

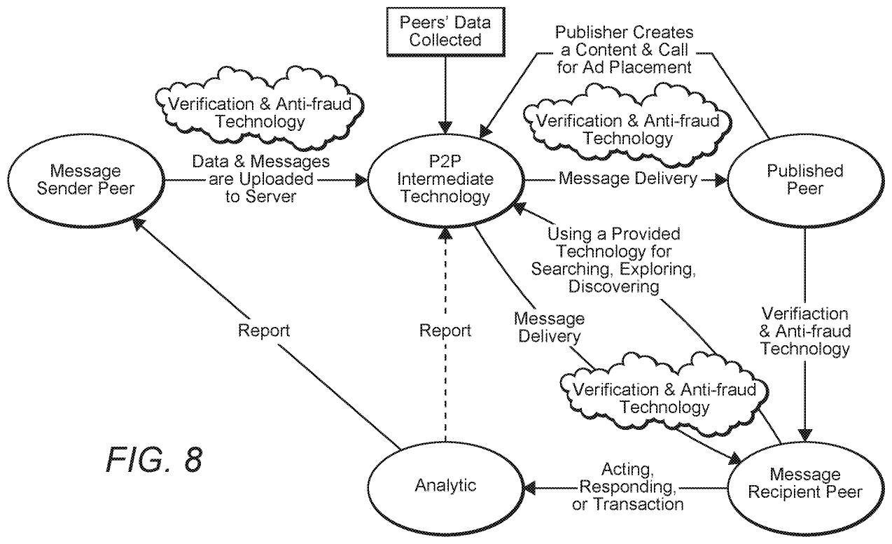

An additional layer of verification occurs as the system monitors physical locations of peers such as via mobile GPS, mac id, or the like. Any event, participation, participant, activity, transaction, and the like need to have corresponding physical locations that the system identifies as acceptable. This helps to identify fraudulent and or repetitive activities from the same location, device, or peer. This measure further improves validity and reduces spam. An exemplary flow chart with verification steps is shown in FIG. 8.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value with a range is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A system for facilitating, securing, verifying, and protecting an interaction between peers, comprising:
a data collection server configured to compile and store user information about a plurality of peers, wherein the user information includes at least one of daily activities, spending habits, hobbies, travels, entertainment, feedback, likes, dislikes, comments, reviews, daily needs, requests, searches, follows, media libraries, interests, surveys, moods, news, location pinpoints, daily schedule, favorite places, advertisement message tracking, and promotion use;
a message server configured to store a first message, wherein the first message comprises message information and message criteria;
a processor configured to compare the message criteria with the stored user information, and generate a set of targets, wherein the processor is further configured to transmit the first message to each target of the set of targets;
wherein the processor is further configured to track interaction with the first message using a digital ledger, such that each interaction by a user is tagged with a time, a location, and user information and recorded on the digital ledger, wherein each interaction comprises a transaction on the digital ledger.

2. The system of claim 1, wherein the user information includes at least one of daily activities, spending habits, hobbies, travels, entertainment, feedback, likes, dislikes, comments, reviews, daily needs, requests, searches, follows, media libraries, interests, surveys, moods, news, location pinpoints, daily schedule, favorite places, ad tracking, offers, discounts and promotion use.

3. The system of claim 1, wherein the user information compiled and stored by the data collection server is limited by a user's permissions.

4. The system of claim 1, wherein the message information comprises at least one of an audio file, a video file, a text file, an image file, a website address, a virtual reality file, and an augmented reality file.

5. The system of claim 1, wherein the message criteria comprises a selection of specific values or a range of values for at least one of demographics, age, gender, language, a home location, a current location, interests, needs, requests, and hobbies of a desired target peer.

6. The system of claim 1, wherein the digital ledger comprises a blockchain as a service technology.

7. The system of claim 1, wherein the processor is further configured to review the transactions on the digital ledger and determine what patterns exist among the transactions by examining transmission of messages and interactions of the transmitted messages.

8. The system of claim 1, wherein the digital ledger comprises a searchable index that contains one or more of the following: a user information, a location, a time, a viewing time, an internet address, a feedback, a response, and a channel for the message.

9. The system of claim 1, wherein the set of targets comprises a plurality of users.

10. The system of claim 1, wherein the set of targets comprises at least one physical location.

11. The system of claim 1, wherein the interaction comprises a direct communication between a user and an owner of the message through an available delivery channel.

12. The system of claim 11, wherein the direct communication occurs via a virtual channel that comprises one of a game, a forum, an augmented reality overlay, a mobile application, and a webpage.

13. The system of claim 1, wherein the interaction comprises a purchase of an item or service via the first message.

14. The system of claim 1, wherein the processor is further configured to determine a location of each target of the set and verify the location for each target by comparing the location to a history of previous locations visited by that target.

15. The system of claim 1, wherein the first message further comprises a value to be rewarded for interaction with the first message.

16. The system of claim 15, wherein the value comprises at least one of points, money, an item, and a ticket for a drawing.

17. The system of claim 1, wherein the first message further comprises a message channel, and wherein the message channel instructs the system what platform to use to transmit the first message.

18. The system of claim 17, wherein the channel is selected from the group consisting of a physical location, a publisher, a social media platform, an augmented reality platform, a virtual reality platform, and software application.

19. A method of facilitating, securing, verifying, and protecting an interaction between peers, comprising:
storing user information about a plurality of peers in a data collection server, wherein the user information includes at least one of daily activities, spending habits, hobbies, travels, entertainment, feedback, likes, dislikes, comments, reviews, daily needs, requests, searches, follows, media libraries, interests, surveys, moods, news, location pinpoints, daily schedule, favorite places, ad tracking, and promotion use;
wherein the stored information about each peer comprises only the information that the peer consented to be stored;
saving a message to a message server, wherein the message comprises content and message criteria;
comparing the message criteria with the stored user information to generate a first set of targets;
transmitting the message to each of the targets of the first set; and
tracking interaction with the message by each target using a digital ledger, such that each interaction by a target is tagged with a time, a location, and user information and recorded on the digital ledger, wherein each interaction comprises a transaction on the digital ledger.

20. The method of claim 19, wherein the message criteria comprise a physical location, and wherein the message is transmitted to targets located within a predetermined range from the physical location.

21. The method of claim 19, further comprising:
receiving a bid from an owner of the message; and
transmitting the message only if the bid meets a predefined criterion.

22. The method of claim 19, wherein the digital ledger comprises a blockchain as a service technology.

23. The method of claim 19, wherein the message further comprises a message channel, and wherein the message channel instructs the system what platform to use to transmit the message.

24. The method of claim 23, wherein the channel is selected from the group consisting of a physical location, a publisher, a social media platform, an augmented reality platform, a virtual reality platform, and software application.
